(19) United States
(12) Patent Application Publication
(10) Pub. No.: US 2025/0326273 A1
(43) Pub. Date: Oct. 23, 2025

(54) VEHICLE

(71) Applicant: TOYOTA JIDOSHA KABUSHIKI KAISHA, Toyota-shi (JP)

(72) Inventor: Manabu ISHIMOTO, Miyoshi-shi (JP)

(73) Assignee: TOYOTA JIDOSHA KABUSHIKI KAISHA, Toyota-shi (JP)

(21) Appl. No.: 18/991,757

(22) Filed: Dec. 23, 2024

(30) Foreign Application Priority Data
Apr. 23, 2024 (JP) 2024-069545

(51) Int. Cl. B60H 1/14; B60K 17/35

(52) U.S. Cl. CPC B60H 1/14; B60K 17/35

(57) ABSTRACT

The vehicle is a four-wheel drive vehicle based on a front-wheel drive. The front wheel-side transaxle includes a front wheel motor, a reduction gear, and a differential gear, and transmits a driving force of the front wheel motor to the front wheels. The front wheel-side transaxle includes a disconnection mechanism. The air conditioner uses the heat generated in the front wheel-side transaxle for heating the vehicle cabin. When there is a heating request and the disconnection mechanism is disconnected, the control ECU makes a connection request for the disconnection mechanism if the first condition is not satisfied. Heat generated by the front wheel-side transaxle can be used to heat the vehicle cabin.

### CROSS-REFERENCE TO RELATED APPLICATION

This application claims priority to Japanese Patent Application No. 2024-069545 filed on Apr. 23, 2024, incorporated herein by reference in its entirety.

### BACKGROUND

### 1. Technical Field

The present disclosure relates to a vehicle.

### 2. Description of Related Art

Japanese Unexamined Patent Application Publication No. 2020-165604 (JP 2020-165604 A) discloses a refrigerant circuit device applied to an air conditioner of a battery electric vehicle. In this refrigerant circuit device, heat of a battery, an inverter, or the like, which is absorbed by a chiller disposed in a refrigerant circuit (heat pump cycle), is used for heating in a vehicle cabin. The heat of the battery, the inverter, or the like is absorbed by the chiller by a low temperature-side heat medium circuit and transported to a heater core of the air conditioner.

### SUMMARY

In some cases, heat (waste heat) generated in a transaxle that transmits a drive force of a drive motor (motor generator) to wheels is utilized for heating in a vehicle cabin. A four-wheel drive vehicle includes a front wheel-side transaxle for driving front wheels and a rear wheel-side transaxle for driving rear wheels. In some cases, the transaxle is provided with a disconnection mechanism in order to improve energy consumption efficiency by eliminating the rotation of the transaxle or the drive motor due to the rotation of driven wheels when switching is made from the four-wheel drive state to the two-wheel drive state. When the disconnection mechanism is brought into the disconnected state, the torque transmission from the driven wheels to the drive motor is disconnected, suppressing the transaxle or the drive motor being rotated accordingly.

When the disconnection mechanism is brought into the disconnected state to suppress the transaxle or the drive motor being driven accordingly, the amount of heat generated by the transaxle is reduced, or no heat is generated by the transaxle at all. Therefore, heat generated by the transaxle cannot be effectively utilized for heating in the vehicle cabin.

An object of the present disclosure is to effectively utilize heat generated by a transaxle for heating in a vehicle cabin.

An aspect of the present disclosure provides a vehicle including:
a front wheel-side transaxle that transmits a drive force of a front wheel motor to front wheels;
a rear wheel-side transaxle that transmits a drive force of a rear wheel motor to rear wheels; a heating device that performs heating in a vehicle cabin;
a heat management device that utilizes heat generated by the front wheel-side transaxle and heat generated by the rear wheel-side transaxle for the heating; and
a control device, in which
at least one of the front wheel-side transaxle and the rear wheel-side transaxle includes a disconnection mechanism that connects and disconnects torque transmission.
   The control device is configured to perform the torque transmission by bringing the disconnection mechanism into a connected state when there is a heating request for the heating device.

According to this configuration, the control device brings the disconnection mechanism into the connected state when there is a heating request for the heating device. Even when the vehicle is in the two-wheel drive state, rotation of the transaxle or the drive motor due to rotation of the driven wheels occurs. Therefore, a decrease in the amount of heat generated by the transaxle is suppressed, and the heat generated by the transaxle can be effectively utilized for heating in the vehicle cabin.

Preferably, the control device may be configured to maintain the disconnection mechanism in a disconnected state when it is estimated that an amount of heat dissipation from the transaxle in the disconnected state to atmosphere is equal to or greater than a predetermined value when the disconnection mechanism is in the disconnected state and the torque transmission is disconnected when there is a heating request for the heating device.

According to this configuration, the disconnection mechanism is maintained in the disconnected state when it is estimated that the amount of heat dissipation from the transaxle to the atmosphere is equal to or greater than a predetermined value. When the heat dissipation amount of the transaxle is large, there is no great expectation for using the heat generated by the transaxle for heating. In such a case, the energy consumption efficiency can be improved by maintaining the disconnection of the disconnection mechanism.

Preferably, the heat management device may be configured to be able to switch between a transport state in which heat generated by the transaxle including the disconnection mechanism is transported to the heating device and a stop state in which such heat transfer is stopped. The control device may be configured to bring the disconnection mechanism into the connected state when the disconnection mechanism is in a disconnected state and the torque transmission is disconnected when there is a heating request for the heating device, and bring the heat management device into the transport state when a temperature of lubricating oil of the transaxle including the disconnection mechanism in the connected state is equal to or higher than a predetermined temperature, and bring the heat management device into the stop state when the temperature of the lubricating oil is lower than the predetermined temperature.

According to this configuration, the heat generated by the transaxle is transported to the heating device when the temperature of lubricating oil of the transaxle is equal to or higher than a predetermined temperature, and the transport of the heat to the heating device is stopped when the temperature of the lubricating oil is lower than the predetermined temperature. When the temperature of lubricating oil of the transaxle is low and less than a predetermined value, the transport of heat is stopped, and thus the temperature of the lubricating oil of the transaxle can be increased early, and thus the heat generated by the transaxle can be effectively used for heating in the vehicle cabin.

Preferably, the control device may be configured to bring the disconnection mechanism into the connected state and bring a motor of the transaxle including the disconnection mechanism into a driving state when the disconnection mechanism is in a disconnected state and the torque transmission is disconnected when there is a heating request for the heating device.

According to this configuration, when there is a heating request for the heating device when the disconnection mechanism is in the disconnected state and the torque transmission is disconnected, the control device brings the disconnection mechanism into the connected state, and brings the motor into the driving state. When there is a heating request for the heating device when the vehicle is in the two-wheel drive state, the four-wheel drive state is established, and thus the heat generated by the transaxle can be effectively used for heating in the vehicle cabin.

Preferably, the vehicle may further include a navigation device that performs route guidance for the vehicle. The control device may be configured to connect the disconnection mechanism when a distance between a destination for the route guidance and a current position is equal to or greater than a predetermined distance when there is a heating request for the heating device when the disconnection mechanism is in a disconnected state and the torque transmission is disconnected.

According to this configuration, the disconnection mechanism is connected when the distance between the destination and the current position is such a distance that the amount of heat generated by the rotation of the transaxle is sufficient. As a result, it is possible to achieve both effective utilization of heat generated by the transaxle and improvement of consumption efficiency of energy consumption.

According to the present disclosure, it is possible to effectively utilize heat generated by a transaxle for heating in a vehicle cabin.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a schematic configuration of a vehicle according to an embodiment of the present disclosure;

FIG. 2A is a diagram showing the flow of heat during heating of the air conditioner;

FIG. 2B is a diagram showing the flow of heat during heating of the air conditioner;

FIG. 3 is a flow chart illustrating an exemplary heating control performed in the control ECU;

FIG. 4 is a flow chart illustrating an exemplary heating-time control executed by the control ECU in the second embodiment;

FIG. 5 is a flow chart illustrating an exemplary heating-time control executed by a control ECU in the third embodiment; and

FIG. 6 is a flow chart illustrating an exemplary heating-time control executed by the control ECU in the fourth embodiment.

### DETAILED DESCRIPTION OF EMBODIMENTS

An embodiment of the present disclosure will be described in detail with reference to the drawings. The same or corresponding parts in the drawings are designated by the same reference signs and repetitive description will be omitted.

### First Embodiment

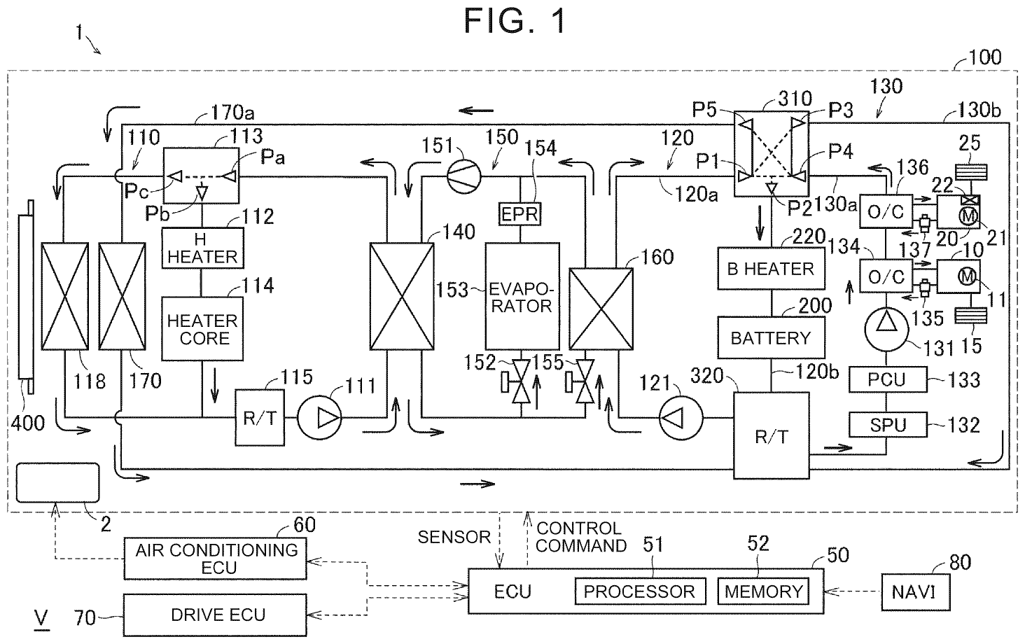

FIG. 1 is a diagram illustrating a schematic configuration of a vehicle V according to this embodiment. Vehicle V is BEV (battery electric vehicle). Vehicle V includes heat management device 1, rear wheel-side transaxle 10, front wheel-side transaxle 20, air conditioning ECU (Electronic Control Unit) 60, drive ECU 70, navigation device 80, and control ECU 50.

The heat management device 1 is configured to perform heat management of the vehicle V using the heat medium of the heat management circuit 100. The heat management circuit 100 includes a first circuit 110, a second circuit 120, and a third circuit 130. The heat management circuit 100 also includes a condenser 140, a refrigerant circuit 150, a chiller 160, a five-way valve 310, and a reservoir tank (R/T) 320. The five-way valve 310 and the reservoir tank 320 are shared by the second circuit 120 and the third circuit 130. The condenser 140, the refrigerant circuit 150, and the chiller 160 are disposed between the first circuit 110 and the second circuit 120. The second circuit 120, the third circuit 130, and 25 the flow path 170a to be described later are also referred to as a low-temperature-side circuit hereinafter.

The first circuit 110 includes a first flow path through which the high-temperature-side heat medium flows. The first circuit 110 includes a pump 111, an electric heating heater 112, a three-way valve 113, a heater core 114, a R/T 115, and a high temperature radiator 118. The three-way valve 113 switches the path of the hot-side heating medium. The pump 111 circulates the hot side heat medium to the first circuit 110. The high-temperature-side heat medium exchanges heat with each device during passage. The heater core 114 is used as a heating source (heat source) of the air conditioner 2. The air conditioner 2 performs heating and cooling of the vehicle cabin.

The five-way valve 310 switches a path (low-temperature-side circuit) of the low-temperature-side heat medium. The five-way valve 310 comprises five-port P1 to P5. ECU 500 controls the five-way valve 310 so as to be one of the first to fifth connecting patterns. Hereinafter, the ports P1, P2, P3, P4, P5 may be referred to as “P1”, “P2”, “P3”, “P4”, and “P5”, respectively.

In the first connection pattern, P1 and P2 are connected, P3 and P4 are connected, and P5 is disconnected. In the second connection pattern, P1 and P2 are connected, P4 and P5 are connected, and P3 is disconnected. In the third connection pattern, P1 and P5 are connected, P3 and P4 are connected, and P2 is disconnected. In the fourth connection pattern, P2 and P4 are connected, P1 and P3 are connected, and P5 is disconnected. In the fifth connection pattern, P2 and P4 are connected, P1 and P5 are connected, and P3 is disconnected.

A flow path 120a, 120b is connected to each of the port P1, P2 of the five-way valve 310. The flow path 120a is a flow path connecting the port P1 and the reservoir tank 320. The flow path 120b is a flow path connecting the port P2 and the reservoir tank 320. When P1 and P2 of the five-way valve 310 are connected (for example, first and second connection patterns), the second circuit 120 including the flow path 120a and 120b is formed.

A pump 121 and a chiller 160 are disposed in the flow path 120a. A battery 200 and electric-type battery heaters 220 are disposed in the flow path 120b. The pump 121 circulates the low-temperature-side heat medium to the second circuit 120. The low-temperature-side heat medium exchanges heat with each device during passage. For this purpose, each device comprises a heat exchanger (or has the function of a heat exchanger).

A flow path 130b, 130a is connected to each of the port P3, P4 of the five-way valve 310. The flow path 130b, 130a is a flow path connecting the port P3, P4 and the reservoir tank 320, respectively. P3 and P4 of the five-way valve 310 are connected to each other (for example, the first and third connection patterns) to form the third circuit 130 including the flow path 130a and 130b.

The high temperature side heat medium may be a known heat medium for heating, and the low temperature side heat medium may be an insulating oil or an antifreeze. Further, in the refrigerant circuit 150 described later, a refrigerant such as hydrofluorocarbon (HFC), ammonia, or carbon dioxide may be used.

In the flow path 130a, a pump 131, a SPU (Signal Processing Unit) 132, a motor PCU (Power Control Unit) 133, and an oil cooler (O/C) 134, 136 are disposed. The oil cooler 134 cools the rear wheel-side transaxle 10, and the oil cooler 136 cools the front wheel-side transaxle 20.

The rear wheel-side transaxle 10 includes a rear wheel motor (motor generator) 11, a speed reducer (or transmission), and a differential gear, and transmits the driving force of the rear wheel motor 11 to the rear wheel 15. The rear wheel-side transaxle 10 is cooled by the lubricating oil circulating through the rear wheel-side transaxle 10 and the oil cooler 134 by the electric oil pump 135.

The front wheel-side transaxle 20 includes a front wheel motor (motor generator) 21, a speed reducer (or a transmission), and a differential gear, and transmits the driving force of the front wheel motor 21 to the front wheels 25. The front wheel-side transaxle 20 is cooled by the lubricating oil circulating through the front wheel-side transaxle 20 and the oil cooler 136 by the electric oil pump 137.

The front wheel-side transaxle 20 is provided with a disconnection mechanism 22. In the present embodiment, the disconnection mechanism 22 is disposed in the torque transmission path between the side gear and the front wheel 25 of the differential gear. In the connected state (engaged state) of the disconnection mechanism 22, torque is transmitted between the differential gear and the front wheel 25. When the disconnection mechanism 22 is in the disconnected state, the torque transmission is disconnected. The disconnection mechanism 22 may be composed of an electromagnetic clutch, a dog clutch, or the like, and in this case, the torque transmission between the differential gear and the front wheel 25 is disconnected in the disconnected state. The disconnection mechanism 22 may be constituted by a one-way clutch with a lock mechanism or the like. In this case, in the cutting state, the torque transmission from the front wheel 25 to the differential gear is cut, but the torque transmission from the differential gear to the front wheel 25 is not cut. In the present disclosure, the disconnection state of the disconnection mechanism is a state in which at least the torque transmission from the wheel to the motor generator is disconnected.

The rear wheel-side transaxle 10 and the front wheel-side transaxle 20 may be so-called e-axles in which inverters (motor PCU), motor generators, reducers (or transmissions), and differential gears are integrated.

The pump 131 circulates the low-temperature-side heat medium to the third circuit 130. The low-temperature-side heat medium exchanges heat with each device during passage. For this purpose, each device comprises a heat exchanger (or has the function of a heat exchanger).

A flow path 170a is connected to a port P5 of the five-way valve 310. The flow path 170a is a flow path connecting the port P5 and the reservoir tank 320. A low-temperature radiator 170 is provided in the flow path 170a. The low-temperature radiator 170 functions as a heat exchanger. The low-temperature radiator 170 exchanges heat between the low-temperature-side heat medium flowing through the flow path 170a and the outside air.

The refrigerant circulates in the refrigerant circuit 150. Refrigerant circuit 150 includes a compressor 151, an electric expansion valve 152, an evaporator 153, an evaporative pressure-regulating valve (EPR: Evaporative Pressure Regulator) 154, and an electric expansion valve 155. The compressor 151 compresses and discharges the refrigerant flowing out of the chiller 160. The refrigerant circuit 150 is a refrigeration cycle or a heat pump cycle.

The evaporator 153 is used as a cooling source of the air conditioner 2. The condenser 140 is connected to both the first circuit 110 and the refrigerant circuit 150, and functions as a heat exchanger. The condenser 140 exchanges heat between the high-temperature-side heat medium flowing through the first circuit 110 and the refrigerant circulating through the refrigerant circuit 150. The chiller 160 is connected to both the refrigerant circuit 150 and the flow path 120a, and functions as a heat-exchanger. The chiller 160 exchanges heat between the refrigerant circulating in the refrigerant circuit 150 and the low-temperature-side heat medium flowing through the second circuit 120. As described above, the condenser 140, the refrigerant circuit 150, and the chiller 160 are configured to perform heat transfer between the high-temperature-side heat medium flowing through the first circuit 110 and the low-temperature-side heat medium flowing through the second circuit 120.

The air conditioner 2 heats the vehicle cabin by using the heat dissipation of the condenser 140. The air conditioner 2 corresponds to an example of a “heating device” of the present disclosure. At the time of heating of the air conditioner 2, the three-way valve 113 is connected to the port Pa and Pb, and the high-temperature-side heat medium absorbed in the condenser 140 dissipates heat in the heater core 114, thereby performing heating. It is assumed that, at the time of heating, the five-way valve 310 is set to, for example, the second connection pattern (P1 and P2, P4 and P5 are connected), and the battery 200 is cooled in the low-temperature-side circuit. In this case, heat (waste heat) of the battery 200 absorbed by the low-temperature-side heat medium is absorbed by the refrigerant in the refrigerant circuit 150 in the chiller 160. Since the heat of the battery 200 is absorbed by the high-temperature-side heat medium in the condenser 140, the heat (waste heat) of the battery 200 is used for heating. In this way, a mode in which the heating and the cooling of the battery 200 are simultaneously executed is referred to as a first mode.

At the time of heating of the air conditioner 2, when the cooling demand of the battery 200 disappears, in order to stop the cooling of the battery 200, the low-temperature-side circuit is switched, for example, the five-way valve 310 is set to the third connection pattern (P1 and P5, P3 and P4 are connected). Then, since the low-temperature-side heat medium cannot exchange heat with the battery 200, heat (waste heat) of the battery 200 cannot be used for heating. In this case, when the temperature of the low-temperature-side heat medium is lower than the outside air, the low-temperature-side heat medium absorbs the heat of the outside air in the low-temperature radiator 170. The low-temperature-side heat medium absorbs heat from the motor PCU 133 and the oil cooler 134, 136. Since the heat is absorbed by the refrigerant in the refrigerant circuit 150 in the chiller 160, the heat of the outside air, the motor PCU 133, and the oil cooler 134, 136 is used for heating. In this way, a mode in which the battery 200 is not cooled but is heated is referred to as a second mode.

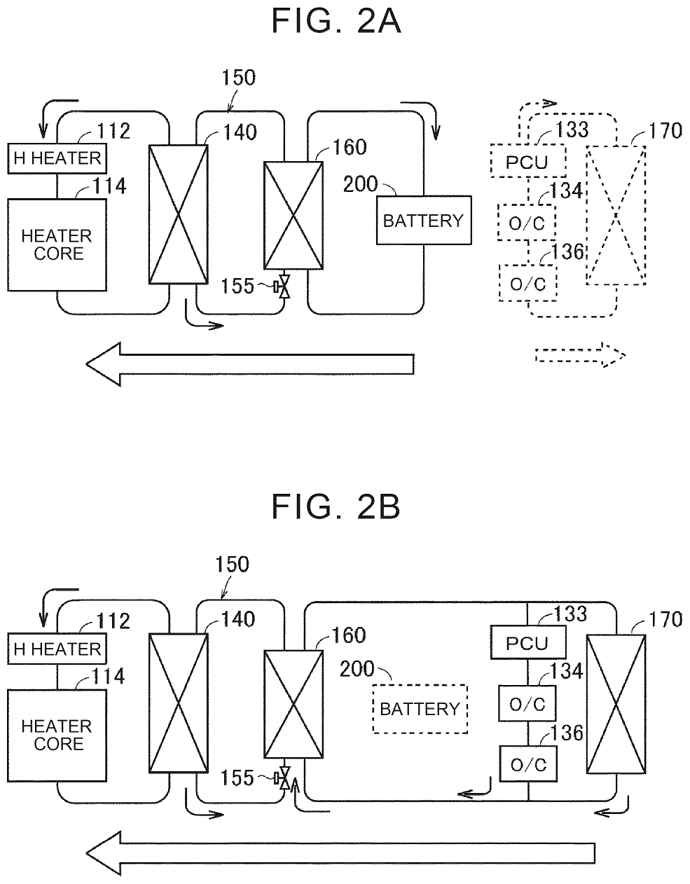

FIGS. 2A and 2B are each a diagram showing the flow of heat during heating of the air conditioner 2. FIG. 2A shows the flow of heat during heating in the first mode, and FIG. 2B shows the flow of heat during heating in the second mode. In the second mode, as shown in FIG. 2B, heat (waste heat) of the motor PCU 133 and the oil cooler 134, 136, which is absorbed by the low-temperature-side heat medium, is absorbed by the refrigerant of the refrigerant circuit 150 in the chiller 160. The waste heat is absorbed by the high-temperature-side heat medium in the condenser 140 and dissipated from the heater core 114. Therefore, heat generated in the rear wheel-side transaxle 10 and the front wheel-side transaxle 20 is used for heating. In the first mode, as shown in FIG. 2A, the heat of the battery 200 is dissipated from the heater-core 114 and used for heating.

The control ECU 50 controls the heat management device 1 (heat management circuit 100). The control ECU 50 includes a processor 51 and memories 52. The processor 51 executes the program stored in the memory 52, thereby executing various types of thermal control in the control ECU 50.

The air conditioning ECU 60 controls the air conditioner 2. For example, when the temperature in the vehicle cabin falls below the air-conditioning temperature set value, the air conditioner 2 performs heating. When the heating switch is turned ON, heating is performed by the air conditioner 2. When heating is performed by the air conditioner 2, the air conditioning ECU 60 transmits a heating demand to the control ECU 50.

The drive ECU 70 controls the distribution of the driving force between the front wheels 25 and the rear wheels 15. In the present embodiment, the vehicle V is a four-wheel drive based on the rear-wheel drive, and in the two-wheel drive state, the drive force distribution on the front wheel side becomes 0 (zero). The driving force distribution is determined by, for example, a vehicle speed, an acceleration/deceleration (front/rear acceleration), a driving slip ratio of the front wheels/rear wheels, a front/rear wheel load, and the like. The drive ECU 70 controls the rear-wheel motor 11 and the front-wheel motor 21 so as to achieve the determined driving force distribution.

When the driving force distribution of the front wheels 25 becomes 0 and the two-wheel driving state, the drive ECU 70 controls the disconnection mechanism 22 to the cutting state and transmits the disconnection mechanism 22 to the control ECU 50 that it is in the cutting state.

The navigation device 80 performs route guidance. The navigation device 80 includes a GPS (Global Positioning System) and, when a destination is set, calculates a travel distance (route distance) from the current position to the destination and performs route guidance from the current position to the destination.

The vehicle V is provided with a grille shutter 400 that blocks the entry of the traveling wind into the engine compartment and reduces the air resistance of the vehicle V. For example, a motor PCU 133 and a front wheel-side transaxle 20 are disposed in the engine compartment. When the temperature in the engine compartment becomes equal to or higher than the threshold value, the grille shutter 400 is opened to actively ventilate (cool) the engine compartment. The grille shutter 400 may be closed when the vehicle speed is higher than or equal to a predetermined value. The engine compartment is a space below the front hood.

When heating is performed in the second mode, in the case of two-wheel driving, the driving force distribution of the front wheels 25 becomes 0, the front wheel motor 21 is stopped, and the disconnection mechanism 22 is in the disconnected state. Therefore, the amount of heat generated in the front wheel-side transaxle 20 is reduced or no heat is generated. Therefore, the amount of heat dissipated from the heater core 114 decreases, and the heating performance deteriorates. In order to suppress the decrease, there is a concern that the power consumption of the heating heater 112 increases.

In the present embodiment, when heating is performed in the second mode in the two-wheel drive state, the heat generated in the front wheel-side transaxle 20 is effectively used for heating in the vehicle cabin by connecting the disconnection mechanism 22.

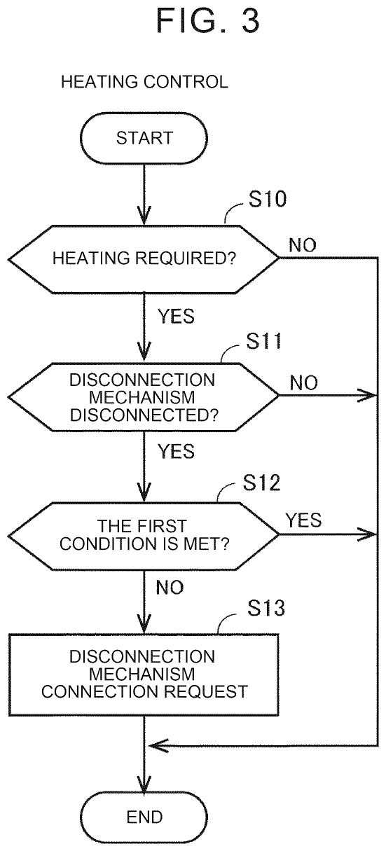

FIG. 3 is a flow chart illustrating an exemplary heating-time control performed in the control ECU 50. This flow chart is repeatedly processed at predetermined intervals when the power switch (ignition switch) of the vehicle V is ON. In step (hereinafter, step is abbreviated as “S”) 10, it is determined whether or not there is a heating request. If heating is performed by the air conditioner 2 and there is a heating demand, an affirmative determination is made and the process proceeds to S11. When there is no heating request, the present routine is ended.

In S11, it is determined whether or not the disconnection mechanism 22 is disconnected. In the two-wheel drive state, when the disconnection mechanism 22 is in the disconnected state, an affirmative determination is made, and the process proceeds to S12. When the disconnection mechanism 22 is in the normal connection state (in the four-wheel drive state), a negative determination is made, and the present routine is ended.

In S12, it is determined whether or not the first condition is satisfied. The first condition is established when it is estimated that the amount of heat dissipation from the front wheel-side transaxle 20 to the atmosphere is a traveling state of a predetermined value or more, and there is a concern that the temperature of the lubricating oil of the front wheel-side transaxle 20 does not increase effectively even when the disconnection mechanism 22 is connected. For example, it may be determined that the first condition is satisfied when, for example, A) the vehicle speed is equal to or higher than the set vehicle speed and cooling of the front wheel-side transaxle 20 is promoted by the traveling wind, B) the outside air temperature is equal to or lower than the set temperature and cooling is promoted by the outside air, or C) the grille shutter 400 is open. Note that when A to Care satisfied at the same time, it may be determined that the first condition is satisfied, and when a plurality of combinations of A to C are satisfied, it may be determined that the first condition is satisfied.

If the first criterion is satisfied, an affirmative determination is made in S12, and the present routine is ended. In this case, the disconnection mechanism 22 maintains the disconnected state. When the first condition is not satisfied, a negative determination is made and the process proceeds to S13. In S13, the drive ECU 70 is transmitted to the disconnection mechanism 22, and the routine ends. Upon receiving the connection request from the control ECU 50, the drive ECU 70 controls the disconnection mechanism 22 to be connected.

According to the present embodiment, when there is a heating request for the air conditioner 2, the control device connects the disconnection mechanism 22. Even when the vehicle V is in the two-wheel drive state, rotation of the front wheel-side transaxle 20 transformer or the front wheel motor 21 due to rotation of the front wheel 25 which is a driven wheel occurs. Therefore, a decrease in the amount of heat generated in the front wheel-side transaxle 20 is suppressed. As a result, the heat generated in the front wheel-side transaxle 20 can be effectively used for heating in the vehicle cabin. Further, in the traveling state in which the amount of heat radiation from the front wheel-side transaxle 20 to the atmosphere is equal to or greater than a predetermined value (when the first condition is satisfied), the disconnection state of the disconnection mechanism 22 is maintained. Accordingly, in a case where the heat generated in the front wheel-side transaxle 20 is used for heating and does not have a large expectation, the energy consumption efficiency can be improved by maintaining the disconnection of the disconnection mechanism 22. The control ECU 50, the air conditioning ECU 60, and the drive ECU 70 correspond to an exemplary “control device” of the present disclosure. Note that S12 may be omitted.

### Second Embodiment

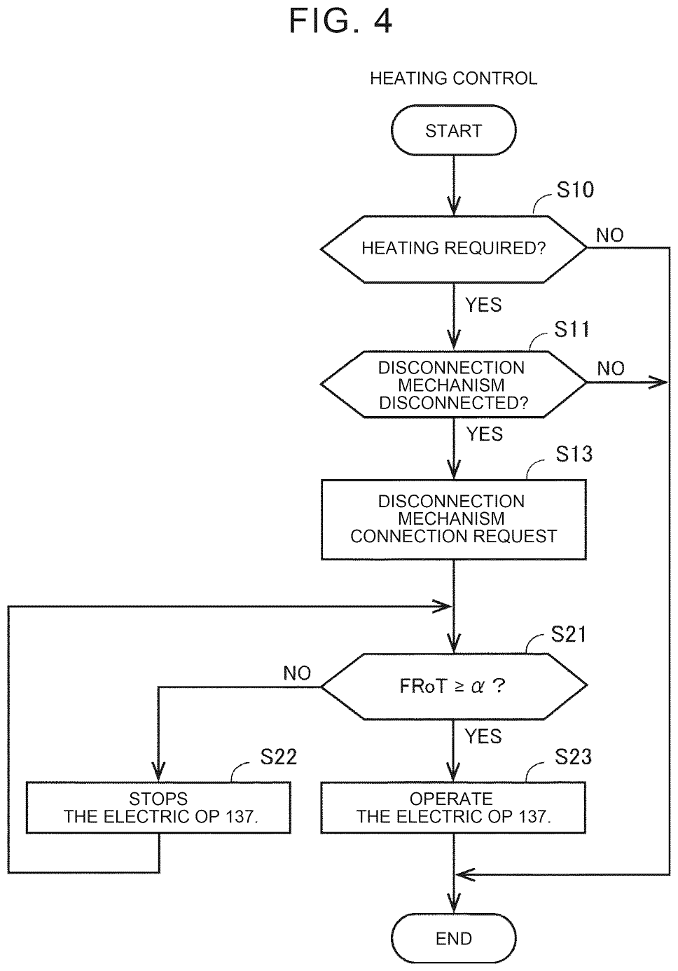

FIG. 4 is a flow chart illustrating an exemplary heating-time control executed by the control ECU 50 in the second embodiment. This flow chart is repeatedly processed at predetermined intervals when the power switch (ignition switch) of the vehicle V is ON. Since S10, S11 and S13 are the same processes as those of S10, S11 and S13 in the first embodiment (FIG. 3), the detailed description thereof will be omitted.

When there is a heating request (affirmative determination in S10) and the disconnection mechanism 22 is disconnected (affirmative determination in S11), a connection request of the disconnection mechanism 22 is made in S13, and the disconnection mechanism 22 is connected. In S21, it is determined whether or not the temperature FRoT of the lubricant of the front wheel-side transaxle 20 is equal to or higher than the predetermined temperature a. When the temperature FRoT is less than the predetermined temperature a, the process proceeds to S22. In S22, the electric oil pump 137 is stopped and the process returns to S21. When the electric oil pump 137 is stopped, since the lubricating oil does not circulate, the heat exchange in the oil cooler 136 is not performed, and the heat generated in the front wheel-side transaxle 20 is not transported to the heater core 114. As a result, the thermal FRoT increases early due to the heat generated by the rotation of the front wheel-side transaxle 20 transformer or the front wheel motor 21.

When the temperature FRoT is equal to or higher than the predetermined temperature α (when the temperature becomes equal to or higher than α), an affirmative determination is made by S21, and the process proceeds to S23. In S23, the electric oil pump 137 is operated, and the present routine is ended. When the electric oil pump 137 is operated, the lubricating oil circulates, heat exchange is performed in the oil cooler 136, and heat generated in the front wheel-side transaxle 20 is transported to the heater core 114. Accordingly, the heat generated in the front wheel-side transaxle 20 can be effectively used for heating in the vehicle cabin.

According to the second embodiment, when the temperature FRoT of the lubricating oil in the front wheel-side transaxle 20 is less than the predetermined value α, the lubricating oil temperature in the front wheel-side transaxle 20 can be increased early. As a result, the heat generated in the front wheel-side transaxle 20 can be effectively used for heating in the vehicle cabin. Note that a bypass passage that bypasses the oil cooler 136 may be provided in the flow path 130a, and in S22, the low-temperature-side heat medium may flow to the bypass passage so that the heat generated in the front wheel-side transaxle 20 is not transported to the heater-core 114.

### Third Embodiment

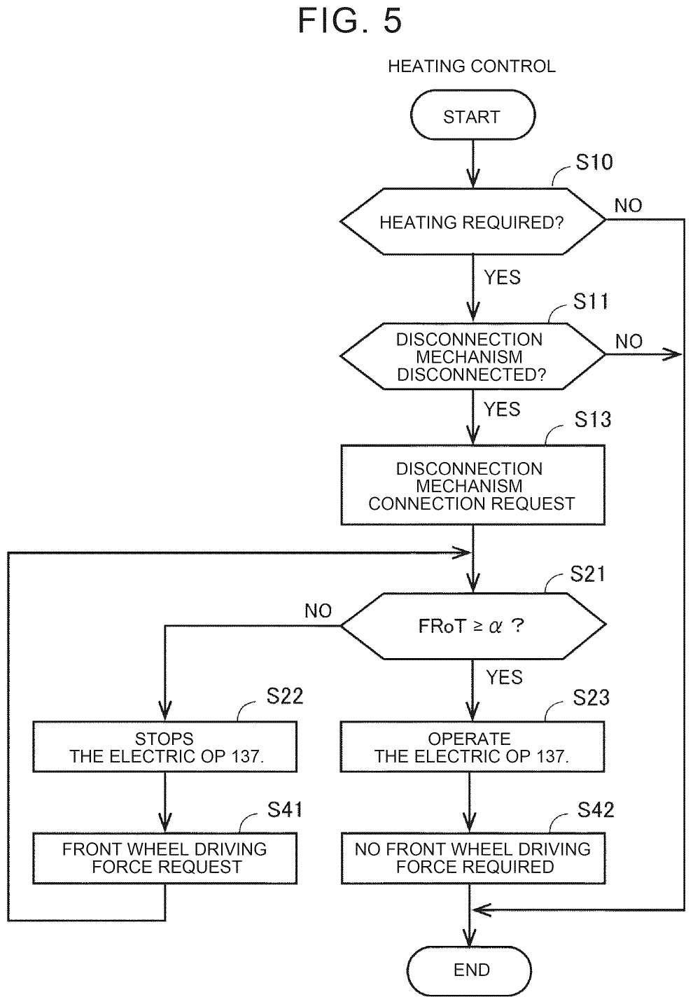

FIG. 5 is a flow chart illustrating an exemplary heating-time control executed by the control ECU 50 in the third embodiment. In this flow chart, S41 is added after the process of S22 of the second embodiment (FIGS. 4), and S41 is added after the process of S23. S41 requires a driving force to the front wheels 25. When there is a demand for a driving force to the front wheel 25, the drive ECU 70 distributes the driving force to the front wheel motor 21, and changes from the two-wheel driving state to the four-wheel driving state. S42 does not require a driving force to the front wheels 25. When there is no demand for the driving force to the front wheels 25, the drive ECU 70 stops the distribution of the driving force when the driving force is distributed to the front wheel motor 21, and sets the two-wheel driving condition. In the two-wheel drive state, the two-wheel drive is maintained.

According to the third embodiment, when the thermal FRoT of the lubricant in the front wheel-side transaxle 20 is less than the predetermined value a, the front wheel motor 21 is driven, and thus heat generation of the front wheel motor 21 can be expected. As a result, the lubricating oil temperature of the front wheel-side transaxle 20 can be increased at an early stage. The heat generated by the front wheel-side transaxle 20 can be effectively used for heating the vehicle cabin.

In the second embodiment (FIG. 4) and the third embodiment (FIG. 5), the process of S12 (FIG. 3) may be added between the process of S11 and the process of S13.

### Fourth Embodiment

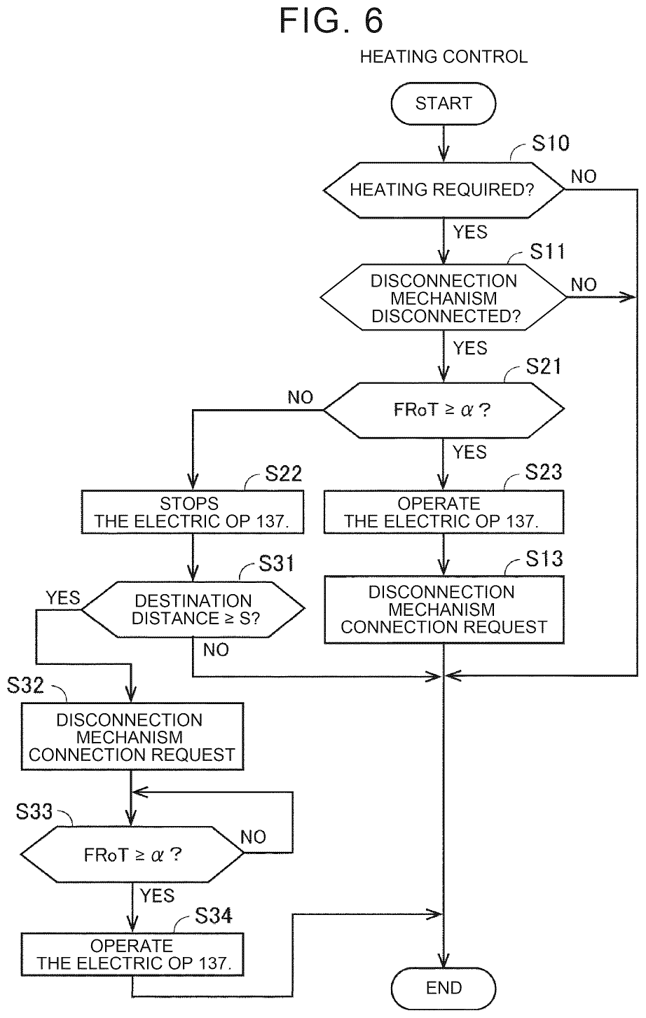

FIG. 6 is a flow chart illustrating an exemplary heating-time control executed by the control ECU 50 in the fourth embodiment. In this flow chart, S10, S11, and S13 are the same processes as those of S10, S11, and S13 in the first embodiment (FIG. 3). In addition, S21, S22 and S23 are the same processes as those of S21, S22 and S23 in the second embodiment (FIG. 4).

In the fourth embodiment, when the temperature FRoT of the lubricating oil in the front wheel-side transaxle 20 is equal to or higher than the predetermined temperature a and an affirmative determination is made in S21, the electric oil pump 137 is operated in S23. Then, in S13, the disconnection mechanism 22 is requested to be connected, and the present routine is ended.

In S22, after the electric oil pump 137 is stopped, the process proceeds to S31 to determine whether or not the travel distance (destination distance) from the present position to the destination set by the navigation device 80 is equal to or greater than the predetermined distance S. The predetermined distance S is a distance at which the heat generated by the rotation of the front wheel-side transaxle 20 when the disconnection mechanism 22 is connected can sufficiently raise the temperature of the lubricating oil, and is a value set by the outside air temperature or the like at that time.

If the destination distance is less than the predetermined distance S, a negative determination is made in S31, and the routine ends. When the destination distance is greater than or equal to the predetermined distance S, the process proceeds to S32 where the disconnection mechanism 22 is requested to be connected, and the process proceeds to S33. If the destination is not set, an affirmative determination is made on S32, and the process may proceed to S33.

In S33, it is determined whether or not the temperature FRoT of the lubricant of the front wheel-side transaxle 20 is equal to or higher than a predetermined temperature a. When the temperature FRoT is lower than the predetermined temperature a, S33 is repeatedly processed, and when the temperature FRoT becomes equal to or higher than the predetermined temperature a, the process proceeds to S33, and the electric oil pump 137 is operated, and the present routine is ended.

According to the fourth embodiment, the disconnection mechanism 22 is connected when the travel distance to the destination is a distance at which the lubricating oil can be sufficiently heated by the heat generated by the entrainment of the front wheel-side transaxle 20. Therefore, it is possible to achieve both effective utilization of heat generated in the front wheel-side transaxle 20 and improvement in efficiency of energy consumption.

In the above embodiment, an example in which the disconnection mechanism 22 is provided in the front wheel-side transaxle 20 has been described. However, when the vehicle V is a four-wheel drive vehicle based on the front-wheel drive, a disconnection mechanism may be provided on the rear wheel-side transaxle 10. In the two-wheel drive state, the drive force distribution of the rear-wheel motor 11 may be set to 0 and the disconnection mechanism may be set to the disconnected state.

Further, a disconnection mechanism may be provided in both the front wheel-side transaxle 20 and the rear wheel-side transaxle 10, and the two-wheel drive state by the front wheel drive and the two-wheel drive state by the rear wheel drive may be switched according to the operating state of the vehicle V.

In addition, in a case where a large heating performance is required by the air conditioner 2, the heating heater 112 provided in the first circuit 110 may be energized to perform heating. Note that the heating heater 112 may not be provided.

The embodiment disclosed herein shall be construed as exemplary and not restrictive in all respects. The scope of the present disclosure is shown by the claims rather than by the above description of the embodiments, and is intended to include all modifications within the meaning and scope equivalent to those of the claims.

What is claimed is:

1. A vehicle comprising:
a front wheel-side transaxle that transmits a drive force of a front wheel motor to front wheels;
a rear wheel-side transaxle that transmits a drive force of a rear wheel motor to rear wheels;
a heating device that performs heating in a vehicle cabin;
a heat management device that utilizes heat generated by the front wheel-side transaxle and heat generated by the rear wheel-side transaxle for the heating; and
a control device, wherein:
at least one of the front wheel-side transaxle and the rear wheel-side transaxle includes a disconnection mechanism that connects and disconnects torque transmission; and
the control device is configured to perform the torque transmission by bringing the disconnection mechanism into a connected state when there is a heating request for the heating device.

2. The vehicle according to claim 1, wherein the control device is configured to maintain the disconnection mechanism in a disconnected state when it is estimated that an amount of heat dissipation from the transaxle in the disconnected state to atmosphere is equal to or greater than a predetermined value when the disconnection mechanism is in the disconnected state and the torque transmission is disconnected when there is a heating request for the heating device.

3. The vehicle according to claim 1, wherein:
the heat management device is configured to be able to switch between a transport state in which heat generated by the transaxle including the disconnection mechanism is transported to the heating device and a stop state in which such heat transfer is stopped; and
the control device is configured to
bring the disconnection mechanism into the connected state when the disconnection mechanism is in a disconnected state and the torque transmission is disconnected when there is a heating request for the heating device, and
bring the heat management device into the transport state when a temperature of lubricating oil of the transaxle including the disconnection mechanism in the connected state is equal to or higher than a predetermined temperature, and bring the heat management device into the stop state when the temperature of the lubricating oil is lower than the predetermined temperature.

4. The vehicle according to claim 1, wherein the control device is configured to bring the disconnection mechanism into the connected state and bring a motor of the transaxle including the disconnection mechanism into a driving state when the disconnection mechanism is in a disconnected state and the torque transmission is disconnected when there is a heating request for the heating device.

5. The vehicle according to claim 1, further comprising a navigation device that performs route guidance for the vehicle, wherein the control device is configured to connect the disconnection mechanism when a distance between a destination for the route guidance and a current position is equal to or greater than a predetermined distance when there is a heating request for the heating device when the disconnection mechanism is in a disconnected state and the torque transmission is disconnected.
